(19) United States
(12) Patent Application Publication
(10) Pub. No.: US 2006/0234558 A1
(43) Pub. Date: Oct. 19, 2006

(54) Combinable connecting means for thin plate-type lithium batteries

(76) Inventor: Kit Wah Li, Kwai Chung (HK)

Correspondence Address: RABIN & Berdo, PC, 1101 14TH STREET, NW, SUITE 500, WASHINGTON, DC, 20005, US

(21) Appl. No.: 11/150,128

(22) Filed: Jun. 13, 2005

(30) Foreign Application Priority Data
Apr. 15, 2005 (CN) 200520016801.3

(51) Int. Cl. H01M 2/10

(52) U.S. Cl. 439/627; 429/121; 429/123; 429/100

(57) ABSTRACT

The invention discloses a combinable connecting means for thin plate-type lithium batteries, characterized in that the combinable connecting means is formed by at least one electrode connecting assembly, wherein the electrode connecting assembly comprises a head portion which receives a electrode connector and on which a receiving slot for the electrode connector is provided; a holding portion for receiving a part of the lithium battery body, on two sides of which a protruding portion and a notch portion corresponding to this protruding portion are respectively arranged, and on one side end surface of which either transverse protruding portions perpendicular to the longitudinal axis of the lithium battery or transverse notch portions corresponding to these transverse protruding portions are arranged. The invention also disclose a electrode connector for use in the combinable connecting means.

### FIELD OF THE INVENTION

The invention relates to the field of lithium batteries, and more particularly, to a combinable connecting means for thin plate-type lithium batteries.

### BACKGROUND OF THE INVENTION

Lithium batteries, in light of their advantages such as large capacity, light weight, small size, are widely used in a variety of electronic products. For high power electronic products, such as engineering equipment, portable equipment, stand-by power supplies, power operated vehicles, power operated wheelchairs, remote-control machinery and models etc, the lithium batteries allow these products to be used satisfactorily and thus become increasingly attractive to the users. With an increasing market for various electronic goods, there remains a need for lithium batteries having a large capacity and high output. In order to be adapted for different needs, the lithium batteries having a large capacity and high output are continuously on the market.

However, the currently available lithium batteries are not convenient to the users. This is mainly due to the lack of hard casing to protect the lithium battery going out from the manufacturing factory, the weakness of the output electrodes, the intolerance of the battery or its electrodes to collision or push-pull by external forces, and the necessity to have a good heat dissipation environment when a high output is required as well as the difficulty in welding the electrodes. As a result, the users can use only the lithium batteries which are already packed or embedded by manufactures, thus greatly restricting the choice of the users and failing to meet the different currents, voltages, electricity capacities and the various mounting applications in engineering. At present, the “packed or embedded lithium batteries” are generally packaged up in a sealing manner so that there is no air circulation in the package. When a high output is produced, the generated heat can not be dispersed effectively, resulting in a risk that the batteries are damaged by the excessive heat or that a too high temperature occurs.

On the other hand, the output electrodes of a lithium battery are currently joined by welding. This welding operation is difficult and inconvenient and if the welding quality is not good, it is easy to cause a danger because of such an imperfect electric contact between the output electrodes.

To accommodate the development of lithium batteries and to meet the market demand, there is a need to design a new combinable connecting means for the lithium batteries to improve the safety of lithium batteries during use, storage and transportation, and to allow the simple combination and connection of the lithium batteries in order to achieve the high capacity and high output.

### BRIEF DESCRIPTION OF THE INVENTION

An object of the invention is to overcome the drawbacks of the prior art and to provide a combinable connecting means for thin plate-type lithium batteries which is convenient to store and transport lithium batteries with safety. By virtue of the combinable connecting means, the lithium batteries may be combined in series or in parallel by the users, if practically necessary, in a manner that the output electrodes of the lithium batteries can be protected from collision damage or from short circuit caused by coming into contact with a foreign body.

The combinable connecting means for thin plate-type lithium batteries is formed by at least one electrode connecting assembly, wherein the electrode connecting assembly comprises a head portion which receives a electrode connector and on which a receiving slot for the electrode connector is provided; a holding portion for receiving a part of the lithium battery body, on two sides of which a protruding portion and a notch portion corresponding to this protruding portion are respectively arranged, and on one side end surface of which either transverse protruding portions perpendicular to the longitudinal axis of the lithium battery or transverse notch portions corresponding to these transverse protruding portions are arranged.

Multiple combinable connecting means can be directly connected either in series in an end-to-end fashion by successively fitting the transverse protruding portions of one connecting means into the corresponding transverse notch portions of another connecting means, or in parallel in a side-to-side fashion by successively having the protruding portion of one connecting means to accommodate the corresponding notch portions of another connecting means.

In the combinable connecting means as mentioned above, its head portion is provided with, on at least one side thereof, a transverse screw hole perpendicular to the longitudinal axis of the lithium battery for receiving a screw bolt such that an electrical connection can be achieved by use of the screw bolt to push or press the electrode connector; its holding portion is arranged with, on two sides thereof, a respective circular hole for increasing its elasticity and anti-deflection capability.

In an embodiment of the invention, the combinable connecting means for thin plate-type lithium batteries is formed by a first electrode connecting assembly, a second electrode connecting assembly and a transverse connecting member connected therebetween, wherein the first assembly is a positive electrode connecting assembly and the second assembly is a negative electrode connecting assembly, on two sides of the holding portion of each assembly are respectively arranged a protruding portion and a notch portion corresponding to this protruding portion, and on one side end surface of the holding portion of the first connecting assembly are arranged transverse protruding portions perpendicular to the longitudinal axis of the lithium battery and on the side end surface of the holding portion of the second connecting assembly are arranged transverse notch portions corresponding to these transverse protruding portions.

As described hereinabove, multiple combinable connecting means having two connecting assemblies can be directly connected either in series in an end-to-end fashion by successively fitting the transverse protruding portions of one connecting means into the corresponding transverse notch portions of another connecting means, or in parallel in a side-to-side fashion by successively having the protruding portion of one connecting means to accommodate the corresponding notch portions of another connecting means.

In another embodiment of the invention, the combinable connecting means for thin plate-type lithium batteries is formed by one electrode connecting assembly, wherein the holding portion of the electrode connecting assembly merely consists of two sides on which a protruding portion and a notch portion corresponding to this protruding portion are respectively arranged. Without transverse protruding portions and corresponding transverse notch portions, such combinable connecting means can serve the parallel connection purpose only.

The receiving slot for the electrode connector may be closed by adhesive paper or film membrane during storage and transportation to protect the output electrodes of the lithium batteries from collision damage or from short circuit caused by accidental contact with other bodies.

An electrode connector is specially designed for use in the combinable connecting means for thin plate-type lithium batteries according to the invention, through which the output electrodes of the lithium batteries can be electrically connected with a standard bolt, without the need of welding equipment. This electrode connector consists of either two parallel clamping members and a transverse piece connected with the two clamping members or two clamping members in a straight line and a transverse piece connected with the two clamping members.

In use, said electrode connector is inserted into the receiving slot arranged on the head portion of the combinable connecting means according to the invention, a screw bolt is then screwed into the transverse screw hole of the head portion to the degree that the front end of the screw bolt press against the clamping member of said electrode connector to allow a tight contact between the output electrode of the lithium battery with said electrode connector, thereby achieving the electrical connection.

According to the invention, the combinable connecting means for thin plate-type lithium batteries can be made of materials such as plastic or nylon and the like, and the electrode connector can be made of copper or any conducting materials.

Both the combinable connecting means for thin plate-type lithium batteries and the electrode connector used therein may be manufactured in a variety of sizes according to the available sizes of lithium batteries. The users may have the lithium batteries to be attached together in a series or parallel arrangement to obtain a desired lithium battery pack. The series or parallel arrangement is easily achieved with a standard tool, particularly convenient for the users. Furthermore, the combinable connecting means according to the invention allows a gap between the batteries after their connection to provide an increased contact surface between the air and the batteries. This improves the air convection among the batteries and the cooling effect so as to significantly reduce the temperature produced at the time of discharging and to prolong the service life of the batteries.

The invention will be described in details in conjunction with the accompanying drawings.

### BRIEF DESCRIPTION OF THE DRAWINGS

FIG. 1 is an appearance view of a typical lithium battery.

FIG. 2 is an appearance view of a combinable connecting means for thin plate-type lithium batteries according to a preferred embodiment of the invention.

FIG. 3 is a front elevation view of the combinable connecting means shown in FIG. 2.

FIG. 4 is a back view of the combinable connecting means shown in FIG. 2.

FIG. 5 is a vertical view of the combinable connecting means shown in FIG. 2.

FIG. 6 is an appearance view of a combinable connecting means for thin plate-type lithium batteries according to another preferred embodiment of the invention.

FIG. 7 is an appearance view of the combinable connecting means shown in FIG. 6 being fixed on a lithium battery.

FIG. 8 is an appearance view of an electrode connector according to a preferred embodiment of the invention.

FIG. 9 is a front elevation view of the electrode connector shown in FIG. 8.

FIG. 10 is an appearance view of an electrode connector according to another preferred embodiment of the invention.

FIG. 11 is a three-dimensional view of a combination of three lithium batteries, showing that the batteries are combined in series by use of the combinable connecting means shown in FIG. 2.

FIG. 12 is a three-dimensional view of a combination of two lithium batteries, showing that the batteries are combined in parallel by use of the combinable connecting means shown in FIG. 2 and the electrode connector shown in FIG. 8.

FIG. 13 is a three-dimensional view of combined lithium batteries with a top cover.

### DETAILED DESCRIPTION OF THE PREFERRED EMBODIMENTS

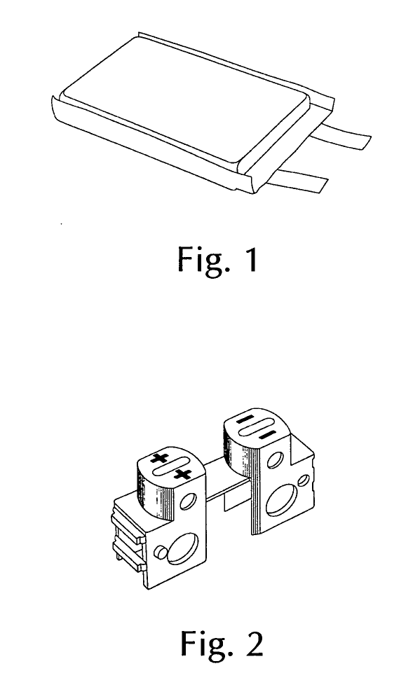

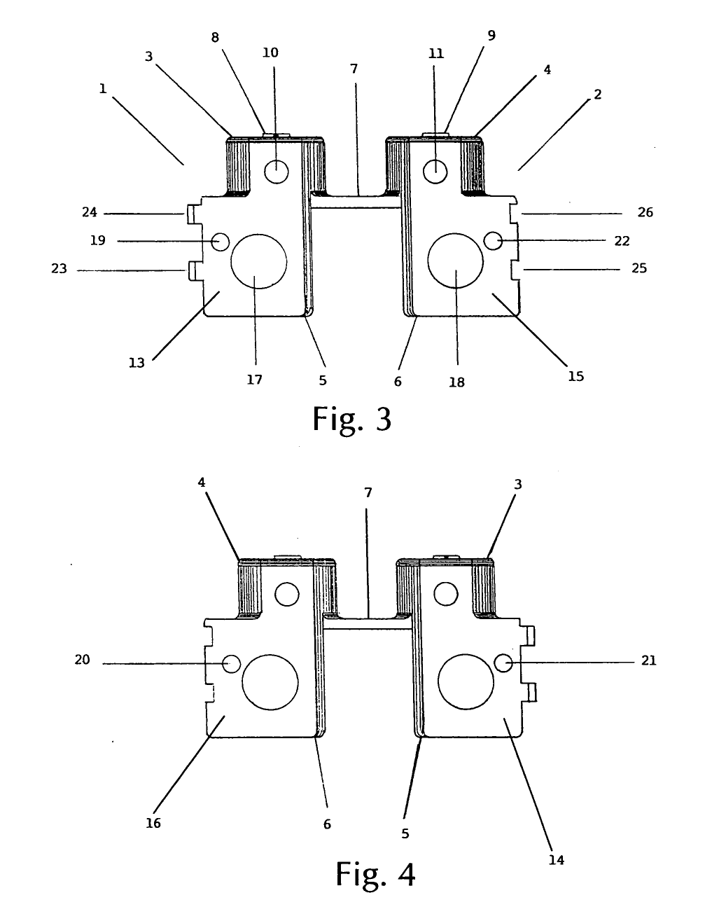

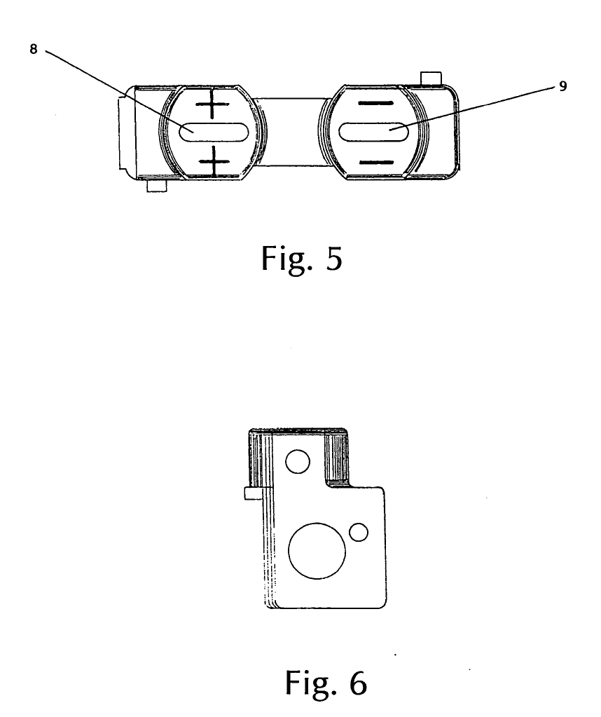

Referring first to FIG. 1, a typical lithium battery is shown. Referring now to FIGS. 2-5, a combinable connecting means for thin plate-type lithium batteries according to a preferred embodiment of the invention is illustrated, wherein the connecting means is formed by a first connecting assembly 1, and a second connecting assembly 2 with a transverse connecting member 7 connected therebetween. The first assembly 1 is a positive electrode connecting assembly and the second assembly 2 is a negative electrode connecting assembly. Each of the two assemblies 1, 2 comprises a head portion 3, 4 and a holding portion 5, 6.

The head portion 3, 4 is provided with, on its top, a receiving slot 8, 9 for a electrode connector and, on each of its two sides, with a transverse screw hole 10, 11 perpendicular to the longitudinal axis of the lithium battery. The holding portion 5, 6 has two sides 13, 14, 15, 16 which extend from the sides of the head portion 3, 4, on which are respectively arranged a protruding portion 19, 20 and a notch portion 21, 22 corresponding to this protruding portion, and are respectively arranged a circular hole 17, 18 for increasing its elasticity and anti-deflection. The holding portion 5 of the first assembly 1 is provided, on its side end surface, with transverse protruding portions 23, 24 perpendicular to the longitudinal axis of the lithium battery and the holding portion 6 of the second assembly 2 is provided, on its side end surface, with transverse notch portions 25, 26 corresponding to these transverse protruding portions 23, 24.

For an easy identification purpose, such symbols as “+” and “−” are shown on the top walls of the head portions, or different colors are used to distinguish the positive electrode connecting assembly from the negative electrode connecting assembly.

It is noted that the number of the electrode connecting assemblies is 2 in the embodiment, but this number may be one or more, for example 4, 6 or 8.

In the event that the combinable connecting means has only one connecting assembly, no transverse connection member is arranged therein and the holding portion thereof has only one side end surface, on which either transverse protruding portions perpendicular to the longitudinal axis of the lithium batteries or transverse notch portions corresponding to these transverse protruding portions are arranged. When the lithium batteries are combined, the connecting means having one connecting assembly in such two forms are used in a paired manner. The method for combining lithium batteries in series or in parallel using the connecting means having one connecting assembly is similar to that using the connecting means having two connecting assemblies. This one-assembly feature is particularly convenient for use in the lithium batteries which are small in size with flexibility. For convenience in connection and for easy identification, the connecting means having one connecting assembly with the transverse protruding portions and the connecting means having one connecting assembly with the corresponding transverse notch portions may be painted with different colors.

For the connecting means having more than two connecting assemblies, it has such a structure that a positive electrode connecting assembly is connected to a negative electrode which is then connected to another positive electrode connecting assembly and so on, with a transverse connecting member between two of the connecting assemblies, wherein the holding potions of the assemblies arranged in the middle of the connecting means are structurally modified for holding the battery body. This multiple-assembly feature is particularly suitable for use in combination of a plurality of lithium batteries in series.

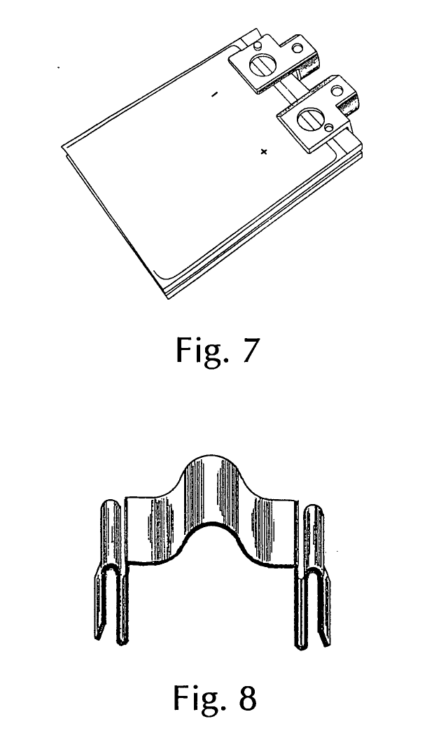

Referring now to FIG. 6, a combinable connecting means for thin plate-type lithium batteries according to another preferred embodiment of the invention is illustrated, wherein the connecting means is formed by one electrode connecting assembly, wherein the electrode connecting assembly has a head portion which is structurally identical to the preceding embodiment, and a holding portion which has no side end surface and consists of two sides on which a protruding portion and a notch portion corresponding to this protruding portion are respectively arranged. Such a connecting means is usually used in the lithium batteries having a larger body width as shown in FIG. 7. Due to the lack of transverse protruding portions and transverse notch portions, this combinable connecting means can merely achieve the parallel combination of the lithium batteries.

The combinable connecting means according to the invention can be fixed on the lithium battery by using adhesive paper or adhesive paste. Adhesive paper, which is generally used for a connecting means having two or more electrode connecting assemblies, fixes the transverse connection member 7 of the combinable connecting means to the lithium battery body. In the event of adhesive paste, it is applied on the inner side surface of the holding portion to attach the lithium battery body.

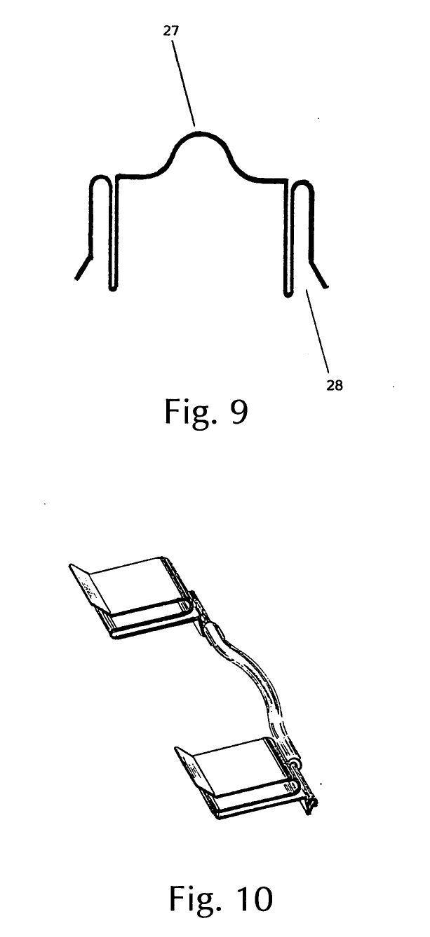

Referring now to FIGS. 8 and 9, an electrode connectors according to a preferred embodiment of the invention is illustrated for use in combining lithium batteries in parallel in most case. This electrode connector consists of two parallel clamping members and a transverse piece connected with the two clamping members, the opening width of the clamping member is such that the output electrode of the lithium battery fits.

The electrode connector can be made of a metal sheet. In a preferred embodiment, it is made of a copper.

FIG. 10 shows an electrode connector according to another preferred embodiment of the invention, which is usually used in combining lithium batteries in series. This electrode connector consists of two clamping members in a straight line and a transverse piece connected with the two clamping members. The transverse piece is welded at its two ends on the top surface of the two clamping members. Generally, this electrode connector is a preformed part.

If connection of the output electrodes of lithium batteries is desired, the batteries are first combined in series or in parallel by use of the connecting means according to the invention and then the electrode connector is inserted into the receiving slot 8,9 of the connecting means. To ensure a good contact between the output electrodes of the lithium batteries and the electrode connector, a standard tool, for example, a screw driver is used to drive respectively two standard screw bolts into the transverse screw hole 10, 11 from two sides of the head portion till the front ends of the screw bolts press against the clamping member 28 of said electrode connector, with a result that the lithium battery electrode tightly comes into contact with said electrode connector, thereby achieving the electrical connection. Afterwards, an output electric wire is coupled with said electrode connector to obtain a desired lithium battery pack which can be used in various electrically-operated products.

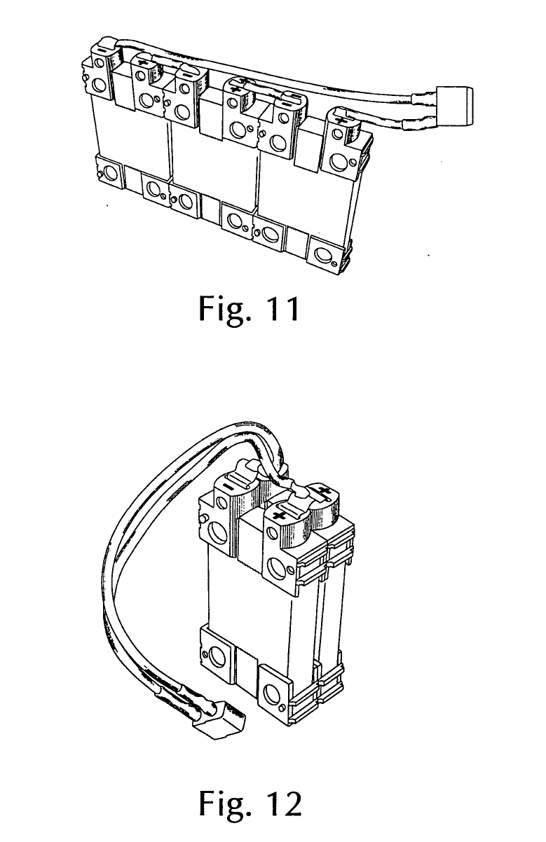

As shown in FIG. 11, when connecting the lithium batteries in series, the two transverse protruding portions 23, 24 of one combinable connecting means for thin plat-type lithium batteries are engaged with the corresponding transverse notch portions 25, 26 of another connecting means for proper alignment, in the same manner, a series connection of a plurality of lithium batteries can be achieved. As shown in FIG. 12, when connecting the lithium batteries in parallel, the protruding portions 19, 20 of two combinable connecting means are respectively inserted into their corresponding notch portions 21, 22, by such an insertion, a parallel connection of a plurality of lithium batteries can be achieved.

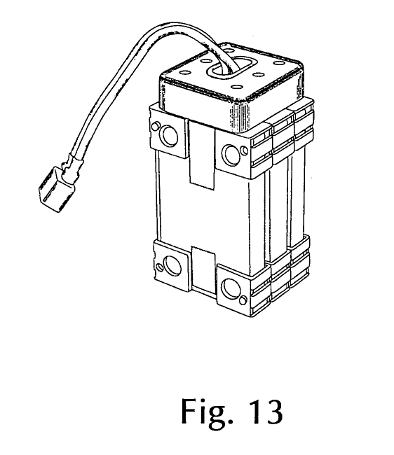

During storage or transportation of lithium batteries, the receiving slot for the electrode connector arranged on the head portion may be closed by adhesive paper or film membrane to protect the output electrode of the lithium batteries from collision damage or from push-pull by external forces. Connection of the output electrodes of multiple lithium batteries may be done by simply removing the adhesive paper or piercing the film membrane and then inserting the electrode connector into the receiving slots. As described above, with a screw bolt, the output electrodes of the lithium battery are allowed to tightly press against the electrode connector according to the invention, so that the combined lithium battery pack can be electrically connected. The lithium battery pack, which is combined by use of the invented combinable connecting means for thin plate-type lithium batteries, may be covered with a top cover and/or a bottom cover to provide a protection and fastening (FIG. 13).

According to the invention, both the combinable connecting means for thin plate-type lithium batteries and the electrode connector may be manufactured and specified in a variety of sizes according to the available sizes of lithium batteries for difference application purposes. The combinable connecting means may be made of plastic materials such as nylon and the like, the electrode connector may be made of conducting metals such as copper.

The combinable connecting means for thin plate-type lithium batteries features light and convenient design as well as flexible use with a protection of lithium batteries from being possibly damaged. It is also easy to obtain a desired lithium battery pack by use of the invented connecting means and a simple tool, which greatly facilitate the users or the engineering personnel in operating the batteries with safety.

While the invention has been particularly shown and described with reference to preferred embodiments thereof, it will be understood by those skilled in the art that the foregoing and other changes in the details, materials and arrangements of the parts may be made therein without departing from the spirit and scope of the invention.

What is claimed is:

1. A combinable connecting means for thin plate-type lithium batteries, characterized in that the combinable connecting means is formed by at least one electrode connecting assembly, wherein the electrode connecting assembly comprises a head portion which receives a electrode connector and on which a receiving slot for the electrode connector is provided; a holding portion for receiving a part of the lithium battery body, on two sides of which a protruding portion and a notch portion corresponding to this protruding portion are respectively arranged, and on one side end surface of which either transverse protruding portions perpendicular to the longitudinal axis of the lithium battery or transverse notch portions corresponding to these transverse protruding portions are arranged.

2. The combinable connecting means as claimed in claim 1, characterized in that the head portion is provided with, on at least one side thereof, a transverse screw hole perpendicular to the longitudinal axis of the lithium battery.

3. The combinable connecting means as claimed in claim 1, characterized in that the holding portion is arranged with, on two sides thereof, a respective circular hole for increasing its elasticity.

4. The combinable connecting means as claimed in claim 1, characterized in that the combinable connecting means is formed by one electrode connecting assembly, wherein the holding portion of the electrode connecting assembly merely consists of two sides on which a protruding portion and a notch portion corresponding to this protruding portion are respectively arranged.

5. The combinable connecting means as claimed in claim 1, characterized in that the combinable connecting means is formed by a first electrode connecting assembly, a second electrode connecting assembly and a transverse connecting member connected therebetween, wherein the first assembly is a positive electrode connecting assembly and the second assembly is a negative electrode connecting assembly, on two sides of the holding portion of each assembly are respectively arranged a protruding portion and a notch portion corresponding to this protruding portion, and on one side end surface of the holding portion of the first connecting assembly are arranged transverse protruding portions perpendicular to the longitudinal axis of the lithium battery and or the side end surface of the holding portion of the second connecting assembly are arranged transverse notch portions corresponding to these transverse protruding portions.

6. The combinable connecting means as claimed in claim 1, characterized in that the number of the connecting assemblies is an even number, the connecting assemblies are connected one another by a transverse connection member.

7. The combinable connecting means as claimed in claim 1, characterized in that the combinable connecting means is made of plastic or nylon.

8. The combinable connecting means as claimed in claim 1, characterized in that the combinable connecting means further comprises an electrode connector.

9. The combinable connecting means as claimed in claim 8, characterized in that the electrode connector consists of two parallel clamping members and a transverse piece connected with the two clamping members.

10. The combinable connecting means as claimed in claim 8, characterized in that the electrode connector consists of two clamping members in a straight line and a transverse piece connected with the two clamping members.

11. The combinable connecting means as claimed in claim 8, characterized in that the electrode connector is made of copper.

12. The combinable connecting means as claimed in claim 9, characterized in that the electrode connector is made of copper.

13. The combinable connecting means as claimed in claim 10, characterized in that the electrode connector is made of copper.

14. The combinable connecting means as claimed in claim 2, characterized in that the combinable connecting means is formed by one electrode connecting assembly, wherein the holding portion of the electrode connecting assembly merely consists of two sides on which a protruding portion and a notch portion corresponding to this protruding portion are respectively arranged.

15. The combinable connecting means as claimed in claim 3, characterized in that the combinable connecting means is formed by one electrode connecting assembly, wherein the holding portion of the electrode connecting assembly merely consists of two sides on which a protruding portion and a notch portion corresponding to this protruding portion are respectively arranged.

16. The combinable connecting means as claimed in claim 2, characterized in that the combinable connecting means is formed by a first electrode connecting assembly, a second electrode connecting assembly and a transverse connecting member connected therebetween, wherein the first assembly is a positive electrode connecting assembly and the second assembly is a negative electrode connecting assembly, on two sides of the holding portion of each assembly are respectively arranged a protruding portion and a notch portion corresponding to this protruding portion, and on one side end surface of the holding portion of the first connecting assembly are arranged transverse protruding portions perpendicular to the longitudinal axis of the lithium battery and on the side end surface of the holding portion of the second connecting assembly are arranged transverse notch portions corresponding to these transverse protruding portions.

17. The combinable connecting means as claimed in claim 3, characterized in that the combinable connecting means is formed by a first electrode connecting assembly, a second electrode connecting assembly and a transverse connecting member connected therebetween, wherein the first assembly is a positive electrode connecting assembly and the second assembly is a negative electrode connecting assembly, on two sides of the holding portion of each assembly are respectively arranged a protruding portion and a notch portion corresponding to this protruding portion, and on one side end surface of the holding portion of the first connecting assembly are arranged transverse protruding portions perpendicular to the longitudinal axis of the lithium battery and on the side end surface of the holding portion of the second connecting assembly are arranged transverse notch portions corresponding to these transverse protruding portions.
